(19) United States
(12) Patent Application Publication
(10) Pub. No.: US 2013/0129895 A1
(43) Pub. Date: May 23, 2013

(54) FAT FILLING WITH VEGETABLE FATS AND SWEETENERS

(71) Applicants: Els Ginette Alexander Dendooven, Grimbergen (BE); Ronny Leontina Marcel Vercauteren, Beveren (BE); Vera Van Limberghen, Asse (BE)

(72) Inventors: Els Ginette Alexander Dendooven, Grimbergen (BE); Ronny Leontina Marcel Vercauteren, Beveren (BE); Vera Van Limberghen, Asse (BE)

(73) Assignee: Cargill, Incorporated, Wayzata, MN (US)

(21) Appl. No.: 13/812,193

(22) PCT Filed: Jul. 27, 2011
(86) PCT No.: PCT/EP2011/003790

§ 371 Date: Jan. 25, 2013

(30) Foreign Application Priority Data
Jul. 29, 2010 (EP) 10007903.7

(51) Int. Cl. A23G 3/38

(52) U.S. Cl. CPC A23G 3/38
USPC 426/548; 426/613; 426/417

(57) ABSTRACT

The present invention relates to a composition comprising fat and sweetener. The fat is present in an amount from 40% w/w to 65% w/w and the sweetener is present in an amount from 30% w/w to 60% w/w. The composition is useful as fat filling in various food products, in particular in confectionery and bakery applications. The preferred use of the composition is to provide a cooling effect to food products, in particular to chocolate.

### FIELD OF THE INVENTION

The present invention relates to a composition comprising fat and sweetener. The composition of the present invention is a fat filling. The composition can be used as a fat filling in food products such as chocolate and bakery products. The composition of the present invention provides a cooling effect upon consumption.

### BACKGROUND OF THE INVENTION

Calorie reduction and product quality are two important facets of food products nowadays. Also, consumers are looking more and more for new and unique eating experiences. It is a big challenge for the food industry to produce calorie reduced food products, having the same or improved organoleptic properties and appealing appearance as the original, non calorie reduced food product.

Today, ice-fillings for chocolate are a popular product; they provide new sensations to the consumer wanting to vary its eating experiences. Ice-fillings are a specific type of fat fillings, they comprise vegetable fat and provide a cooling sensation to the consumer when melting in the mouth. Such ice-fillings are compositions based on the principle that the melting of the fats provides a cooling sensation in the mouth. Indeed, fats having sharp melting points are a common ingredient used in ice-fillings. However, this cooling effect is rather low. Another disadvantage of existing ice-fillings is that they contain one hundred percent of fat, making them highly caloric, while the overall trend in the food industry is to reduce the calorie content of foods. The challenge is then to produce calorie reduced foods having good organoleptic properties and an appealing appearance. There is thus a need for an ice-filling giving a stronger cooling sensation and being at the same time less caloric than the existing fat fillings.

Patent EP0555917 describes the use of combinations of specific triglycerides to provide cooling effects to fat fillings for chocolate products.

U.S. 2002/0106438 A1 relates to lipid based fillings, in particular to lipid-based fillings that have reduced fat and low moisture. U.S. 2010/0136182 A1 describes a fat filling or chocolate substitute with a reduced edible fat and/or sugar content, in particular for cereal based bakery products.

There is still a need for a fat filling that is reduced in calorie and provides a strong cooling effect to the food product comprising it.

### SUMMARY OF THE INVENTION

A first aspect of the invention relates to a composition comprising fat and sweetener, characterized in that it comprises 40% weight/weight (w/w) to 65% w/w of fat, and 30% w/w to 60% w/w of sweetener, and in that it is a fat filling, wherein the sweetener is chosen from the group of dextrose, erythritol, xylitol, arabinitol, sorbitol, mannitol, iditol, galactitol, maltitol, isomaltitol, isomalt, lactitol and mixtures of two or more thereof.

A second aspect of the invention relates to a chocolate comprising a fat filling and other food ingredients, characterized in that the fat filling comprises the composition according to the first aspect of the present invention.

A third aspect of the invention relates to a process for making the composition according to the first aspect of the present invention, characterized in that it comprises the steps of:
a. Taking sweetener having a particle size from 5 μm to 400 μm; and
b. Heating fat to a temperature of from 30° C. to 70° C.; and
c. Mixing the sweetener with the fat to prepare a paste.

A fourth aspect of the invention relates to a use of the composition according to the first aspect of the present invention as a fat filling in food products, such as confectionery products and bakery products.

A fifth aspect of the invention relates to the use of erythritol to reduce the calorie content of the composition according to the first aspect of the present invention.

### DETAILED DESCRIPTION

In a first aspect, the present invention relates to a composition comprising fat and sweetener. The composition is characterized in that it comprises from 40% w/w to 65% w/w of fat and from 30% w/w to 60% w/w of sweetener, and in that it is a fat filling, wherein the sweetener is chosen from the group of dextrose, erythritol, xylitol, arabinitol, sorbitol, mannitol, iditol, galactitol, maltitol, isomaltitol, isomalt, lactitol and mixtures of two or more thereof.

The composition is in a solid form. A paste is seen as a solid form for the purpose of the present invention.

For the purpose of the present invention, a fat filling is defined as a composition comprising fat and sweetener, which is completely or partially surrounded by a shell. Preferably, the fat filling has a softer texture than the surrounding shell. The shell and the fat filling completely or partially surrounded by the shell is typically a food product such as a confectionery product, a bakery product, a breakfast cereal. A confectionery product can be a chocolate, a candy, a brittle, a caramel, a toffee, and the like.

The chocolate may be a dark chocolate, a milk chocolate or a white chocolate. The chocolate may be moulded or extruded to form a chocolate bar (which may have a square, round, or rectangle shape for example); it may be moulded or deposited to form a chocolate of singly mouthful size, for example as what is typically known as a Belgian praline.

In a preferred embodiment, the shell is a chocolate in the form of a chocolate bar.

A bakery product can be a muffin, a cake, a biscuit, a snack, a cereal bar, a granola bar and the like.

A breakfast cereal can be puffed, extruded and the like.

Additionally, the fat filling can also be used in dairy products such as ice creams. In this case the shell can be the ice cream, which can have a softer texture than the fat filling.

The texture of the shell and the fat filling can be measured with conventional methods and apparatus such as TA.XTPlus Texture analyzer.

The term fat is defined as a group of compounds that are generally soluble in organic solvents and largely insoluble in water. Depending on their structure and composition, at room temperature fats may be either solid or liquid, in this case they are also known as oils. The fat of the present composition can be any vegetable fat but it is preferably palm fat, coconut fat, cocoa butter, or mixtures of two or more thereof. Palm fat can be refined, deodorized and bleached palm oil/fat. Coconut fat can be refined, deodorized and bleached coconut oil/fat. Cocoa butter is commonly used to refer to the vegetable fat extracted from cocoa beans.

In the composition according to the present invention, the fat is present in an amount of from 40% w/w to 65% w/w, even more preferably from 45% w/w to 60% w/w. The combination of fat and sweetener allows reducing the calorie content of the composition, compared to a composition containing one hundred percent of fat. This reduction in the calorie content makes the composition according to the present invention more suitable for being part of a healthier diet.

The sweetener in the composition according to the present invention can be polyol and/or dextrose.

By polyols is meant herein sugar alcohols. Sugar alcohols are known to have a reduced caloric content compared to their sugar counterparts. In the present invention, the polyols can be selected form the group of erythritol, xylitol, arabinitol, sorbitol, mannitol, iditol, galactitol, maltitol, isomaltitol, isomalt, lactitol and mixtures of two or more thereof. However, in a preferred embodiment, the composition comprises at least erythritol and/or xylitol. Preferably, the polyol in the composition has a strong negative heat of solution.

Dextrose can be any solid form of dextrose, such as anhydrous dextrose, hydrated forms of dextrose, being amorphous or crystalline.

The sweetener is present in an amount of from 30% w/w to 60% w/w, more preferably from 35% w/w to 55% w/w.

The sweetener of the present invention has a particle size from 5 μm to 400 μm, preferably, the particle size is from 20 μm to 400 μm, more preferably from 50 μm to 400 μm. The measurement of the particle size is based on laser light diffraction and was measured with the Sympatec Particle Sizer. The following method was employed to characterize the particle size:

The size distribution was determined according to the European Pharmacopoeia VI Test method 2.9.31 using a laser light particle sizer, type Helos KF—Rodos T4.1, of Sympatec GmbH (Germany). The particle size was analyzed by laser light diffraction. The method was done following ISO 13320:2009-10, Particle size analysis—Laser diffraction methods.

In one embodiment, the sweetener of the composition is erythritol and sorbitol, in a weight ratio of from 20:80 to 70:30 of erythritol:sorbitol, preferably in a weight ratio of 50:50 of erythritol:sorbitol.

In another embodiment, the sweetener of the composition is erythritol and dextrose, in a weight ratio of from 20:80 to 70:30 of erythritol:dextrose, preferably in a weight ratio of 50:50 erythritol:dextrose.

In yet another embodiment, the sweetener of the composition is erythritol, sorbitol and dextrose, in a weight ratio of from 20:1:79 to 20:79:1 and from 70:1:29 to 70:29:1 of erythritol:sorbitol:dextrose. Preferably in a weight ratio of 50:35:15 to 50:25:25 of erythritol:sorbitol:dextrose. Alternatively, the weight ratio is 50:35:15 or 50:25:25 of erythritol:sorbitol:dextrose.

Further, it has been found that the composition of the present invention comprising the above mentioned ratios of sweetener has a creamy texture and a smooth mouth feel.

Further, the presence of sorbitol in the above mentioned ratios has been found to be particularly interesting in fat fillings to increase the cooling effect of the composition, in comparison to the cooling effect provided by erythritol alone. Without wishing to be bound by theory, it is suggested that there is a synergistic effect between sorbitol and erythritol with regard to cooling effect of the composition of the present invention.

The composition can further comprise ingredients such as high intensive sweeteners, flavours and colorants.

Examples of suitable high intensive sweeteners for the purpose of the present invention can be but are not limited to aspartame, acesulfame salts such as acesulfame-K, saccharins, cyclamates, sucralose, alitame, neotam, steviosides, glycyrrhizin, neohesperidin dihydrochalone, monellin, thaumatin, brazzein, and the like, and mixtures of two or more thereof.

Flavours can be chosen from any flavour approved for food use and in particular those suitable for use in food applications described further in the present invention. Similarly, colouring agents can be chosen from any colouring agent approved for food use and in particular those suitable for use in food applications described further in the present invention.

The composition can further comprise milk, emulsifier and cocoa powder or chocolate powder. Preferably, milk is any concentrated milk paste or milk powder; it can be full fat, partially or totally defatted. Emulsifier can be for example any type of suitable lecithin for food applications.

In another aspect, the present invention relates to a chocolate comprising a fat filling and chocolate ingredients, characterized in that the fat filling is the composition according to the first aspect of the present invention. The chocolate can be in the form of a chocolate bar, in the form of a singly mouthful size, or in other convenient or typical forms. The fat filling represents from 5% w/w to 95% w/w of the total chocolate. In the fat filling of the chocolate according to the present invention, suitable combinations of sweeteners are:
erythritol and sorbitol, in a weight ratio from 20:80 to 70:30 of erythritol:sorbitol, preferably in a weight ratio of 50:50 of erythritol:sorbitol, or
erythritol and dextrose in a weight ratio from 20:80 to 70:30 of erythritol:dextrose, preferably in a weight ratio of 50:50 of erythritol:dextrose, or
erythritol, sorbitol and dextrose, in a weight ratio from 20:1:79 to 20:79:1 and from 70:1:29 to 70:29:1 of erythritol:sorbitol:dextrose; and preferably in a weight ratio of 50:35:15 to 50:25:25 of erythritol:sorbitol:dextrose. Alternatively, the weight ratio is 50:35:15 or 50:25:25 of erythritol:sorbitol:dextrose.

Another aspect of the invention relates to a process for making the composition of the present invention. The process comprises the steps of:
a. Taking sweetener having a particle size from 5 μm to 400 μm; and
b. Heating fat to a temperature of from 30° C. to 70° C.; and
c. Mixing the sweetener with the fat to prepare a paste.

To obtain a sweetener with a particle size of 5 μm to 400 μm, preferably 20 μm to 400 μm, more preferably form 50 μm to 400 μm; any suitable technique known in the art for size reduction of particles may be used, such as milling.

When the composition comprises other ingredients than sweetener and fat, such as milk powder, chocolate powder, emulsifier, those ingredients can be mixed with the sweetener prior to the addition of the fat. If necessary, these ingredients can also be milled separately or together with the sweetener. The emulsifier will preferably be added together with the fat.

Preferably, the paste obtained in step c. of the process will be homogenized. The homogenization can be done by any suitable method known in the art. It can be for example done by passing the paste through a set of rolls.

Further, the paste obtained in step c. can be cooled down to a temperature of from 4 to 20° C.

Preferably, the process for making the composition of the present invention comprises the steps of:
a. Taking sweetener having a particle size from 5 μm to 400 μm; and
b. Heating fat to a temperature of from 30° C. to 70° C.; and
c. Mixing sweetener with 20% w/w to 45% w/w of the total fat to prepare a paste; and
d. Homogenizing the paste obtained in step c; and
e. Mixing the homogenized paste obtained in step d. with the rest of the fat.

The homogenization step can be done by any suitable method known in the art, for example by passing the paste through a set of rolls. A second homogenization can also be done after step e. of the process.

A further aspect of the present invention relates to a use of the composition as a fat filling in various food products, in particular in confectionery products and bakery products.

Confectionery products within the scope of the present invention include chocolate, candies, brittle, caramel, toffee and the like.

A bakery product can be a muffin, a cake, a biscuit, a snack, a cereal bar, a granola bar and the like.

In a preferred embodiment, the composition is used as a fat filling in chocolate.

In a preferred embodiment, the use of the composition according to the first aspect of the present invention is to provide a cooling effect to the food product wherein it is used as a fat filling. Indeed, it has been surprisingly found, that a composition with fat and with sweetener having a strong negative heat of solution, provides a significant cooling effect and has a reduced caloric value. By cooling effect is meant herein that the consumer notes a sensation of freshness when consuming the product containing the fat filling. Such a cooling effect can be measured by the negative heat of solution of the fat filling. The higher the negative heat of solution, the higher the cooling effect will be. It has been found that such a composition can be used as an ideal fat filling for various food products. A fat filling providing a cooling effect may also be known as ice-filling. Moreover, depending on what the consumer is looking for, the cooling effect can be adjusted by adapting the types and ratios of sweeteners in the composition.

It has been found that preferably the sweetener of the composition used as a fat filling is erythritol and sorbitol in a weight ratio from 20:80 to 70:30 of erythritol:sorbitol, preferably in a weight ratio of 50:50 of erythritol:sorbitol.

In another embodiment, the sweetener of the composition used as a fat filling is erythritol and dextrose, in a weight ratio from 20:80 to 70:30 of erythritol:dextrose, preferably in a weight ratio of 50:50 erythritol:dextrose.

In yet another embodiment, the sweetener of the composition used as a fat filling is erythritol, sorbitol and dextrose, in a weight ratio of from 20:1:79 to 20:79:1 and from 70:1:29 to 70:29:1 of erythritol:sorbitol:dextrose. Preferably in a weight ratio of 50:35:15 to 50:25:25 of erythritol:sorbitol:dextrose. Alternatively, the weight ratio is 50:35:15 or 50:25:25 of erythritol:sorbitol:dextrose.

The presence of sorbitol in the above mentioned ratios has been found to be particularly useful in fat fillings to increase the cooling effect in comparison to the cooling effect provided by erythritol alone.

The resulting fat filling also shows a creamy texture and smooth mouth feel.

A further aspect of the invention is the use of erythritol to reduce the calorie content of fat fillings. Erythritol has a zero calorie content and can thus be used to reduce the calorie content of fat fillings by replacing calorie rich ingredients, such as fat, with erythritol. In the fat filling of the present invention, erythritol can be present in an amount of 15% w/w to 60% w/w.

The invention will be illustrated by the following examples.

### EXAMPLES

### Example 1

Compositions 1 to 6 were prepared with following ingredients (in % w/w):

| Ingredients | 1 | 2 | 3 | 4 | 5 | 6 |
|---|---|---|---|---|---|---|
| Erythritol Powder | 22.5 | 22.5 | 22.5 | 21.5 | 21.5 | 21.5 |
| Zerose 01657 (Cargill ) | | | | | | |
| Dextrose Anhydrous | 22.5 | 0 | 11.25 | 21.5 | 10.75 | 0 |
| 2404 (Cargill ) | | | | | | |
| Sorbitol powder 16605 | 0 | 22.5 | 11.25 | 0 | 10.75 | 21.5 |
| (Cargill ) | | | | | | |
| Refined Coconut oil 25 | 44.5 | 44.5 | 44.5 | 44.5 | 44.5 | 44.5 |
| (Cargill) | | | | | | |
| Full milk powder (26%) | 10 | 10 | 10 | 7.5 | 7.5 | 7.5 |
| (N.V. Olympia S.A.) | | | | | | |
| Cocoa powder 10-12%* | 0 | 0 | 0 | 4.5 | 4.5 | 4.5 |
| (Cargill ) | | | | | | |
| Lecithin: Topcithine | 0.5 | 0.5 | 0.5 | 0.5 | 0.5 | 0.5 |
| NGM (Cargill ) | | | | | | |
| Total | 100 | 100 | 100 | 100 | 100 | 100 |

*Contains 10-12% Cacao-butter

The process of preparing the ingredients was as follows:
a. Erythritol powder (Zerose 01657), Dextrose Anhydrous 2404 and Sorbitol powder (Sorbitol 16605), all from Cargill, were milled to a particle size of from 5 μm to 40 μm
b. The fat (Cargill refined Coconut oil 25) was heated to 35° C.
c. The Erythritol powder (Zerose 01657), Dextrose Anhydrous 2404, Sorbitol powder (Sorbitol 16605), the full milk powder and the cocoa powder (Cargill cocoa powder 10-12%) were mixed with 28-35% w/w of the fat to obtain a paste
d. The paste obtained in step c. was passed between rolls
e. The paste obtained in step d. was mixed with the rest of the fat and with the lecithin f. The filling was cooled down

5-10 volunteers were asked to blind taste the prepared fat filling and to describe the magnitude of the sensorial cooling effect, overall taste, texture and creaminess.

All fillings were found to be acceptable in terms of taste, texture and cooling effect. Sorbitol increases the cooling effect of the filling.

### Example 2

Compositions 1 to 4 were prepared from the
following ingredients (in % w/w):

| Ingredients | 1 | 2 | 3 | 4 |
|---|---|---|---|---|
| Erythritol Powder 01657 | 21 | 20.5 | 21 | 20.5 |
| (Cargill) | | | | |
| Dextrose Anhydrous 2404 | 0 | 0 | 21 | 20.5 |
| (Cargill) | | | | |
| Sorbitol powder 16605 | 21 | 20.5 | 0 | 0 |
| (Cargill) | | | | |
| Refined Coconut oil 25 | 47.7 | 48.2 | 47.7 | 48.2 |
| (Cargill | | | | |
| Full milk powder (26%) | 10 | 6 | 10 | 6 |
| (N.V. Olympia S.A.) | | | | |
| Cocoa powder 10-12%* | 0 | 4.5 | 0 | 4.5 |
| (Cargill) | | | | |
| Lecithin: Topcithine NGM | 0.3 | 0.3 | 0.3 | 0.3 |
| (Cargill) | | | | |
| Total | 100 | 100 | 100 | 100 |

*Contains 10-12% Cacao-butter

The process of preparing the ingredients was as follows:
a. Erythritol powder (Zerose 01657), Dextrose Anhydrous 2404 and Sorbitol powder (Sorbitol 16605), all from Cargill, were milled to a particle size of from 5 μm to 40 μm
b. The fat (Cargill refined Coconut oil 25) was heated to 35° C.
c. The Erythritol powder 1657, Dextrose Anhydrous 2404, Sorbitol powder (Sorbitol 16605), the full milk powder and the cocoa powder (Cargill cocoa powder 10-12%) were mixed with 28-35% w/w of the fat to obtain a paste
d. The paste obtained in step c. passed through a set of rolls
e. The fine rolled slurry obtained in step d. was mixed with the rest of the fat and with the lecithin
f. The filling was cooled down

5-10 volunteers were asked to blind taste the prepared fat filling and to describe the magnitude of the sensorial cooling effect, overall taste, texture and creaminess.

All fillings were found to be acceptable in terms of taste, texture and cooling effect. The texture is found to be creamy and smooth.

1.-15. (canceled)

16. A composition comprising:
a fat; and
a sweetener,
wherein the fat is present in an amount of from 40% weight/weight (“w/w”) to 65% w/w and the sweetener is present in an amount of from 30% w/w to 60% w/w, and wherein the sweetener is chosen from the group consisting of dextrose, erythritol, xylitol, arabinitol, sorbitol, mannitol, iditol, galactitol, maititol, isomaltitol, isomalt, lactitol, and mixtures thereof.

17. The composition of claim 16, wherein the fat is selected from the group consisting of pahn fat, coconut fat, cocoa butter, and mixtures thereof.

18. The composition of claim 16, wherein the sweetener comprises erythritol, xylitol, or mixtures thereof.

19. The composition of claim 16, wherein the sweetener is erythritol and sorbitol, and wherein the sweetener is present in a weight ratio of from 20:80 to 70:30 of erythritol:sorbitol.

20. The composition of claim 16, wherein the sweetener is erythritol and sorbitol, and wherein the sweetener is present in a weight ratio of 50:50 of erythritol:sorbitol.

21. The composition of claim 16, wherein the sweetener is erythritol and dextrose, and wherein the sweetener is present in a weight ratio of from 20:80 to 70:30 of erythritol:dextrose.

22. The composition of claim 16, wherein the sweetener is erythritol and dextrose, and wherein the sweetener is present in a weight ratio of 50:50 of erythritol:dextrose.

23. The composition of claim 16, wherein the sweetener is erythritol, sorbitol, and dextrose, and wherein the sweetener is present in a weight ratio of from 20:1:79 to 20:79:1 of erythritol:sorbitol:dextrose.

24. The composition of claim 16, wherein the sweetener is erythritol, sorbitol, and dextrose, and wherein the sweetener is present in a weight ratio of from 70:1:29 to 70:29:1 of erythritol sorbitol:dextrose.

25. The composition of claim 16, wherein the sweetener is erythritol, sorbitol, and dextrose, and wherein the sweetener is present in a weight ratio of 50:35:15 to 50:25:25 of erythritol:sorbitol:dextrose.

26. The composition of claim 16, further comprising a high intensity sweetener.

27. A chocolate comprising:
a fat filling; and
chocolate ingredients,
wherein the fat tilling is the composition of claim 16.

28. A method of making the composition of claim 16, the method comprising:
a. taking a sweetener having a particle size of from 5 μm to 400 μm;
b. heating a fat to a temperature of from 30° C. to 70° C.; and
c. mixing the sweetener with the fin to prepare a paste.

29. A method of making the composition of claim 16, the method comprising:
a. taking a sweetener having a particle size of from 5 μm to 400 μm;
b. heating a fat to a temperature of from 30° C. to 70° C.;
c. mixing the sweetener with 20% w/w to 45% w/w of the total fat to prepare a paste;
d. homogenizing the paste obtained in step c; and
e. mixing the homogenized paste obtained in step d with the rest of the fat.
